(19) United States
(12) Patent Application Publication
(10) Pub. No.: US 2026/0237112 A1
(43) Pub. Date: Aug. 13, 2026

(54) ELECTRONIC APPARATUS FOR PROVIDING FLOATING IMAGE AND CONTROLLING METHOD THEREOF

(71) Applicant: SAMSUNG ELECTRONICS CO., LTD., Suwon-si (KR)

(72) Inventors: Jingun JUNG, Suwon-si (KR); Sunmin Son, Suwon-si (KR); Donghun Kang, Suwon-si (KR); Gayoung Hong, Suwon-si (KR); Sangyoon Lee, Suwon-si (KR); Soyoung Yun, Suwon-si (KR)

(73) Assignee: SAMSUNG ELECTRONICS CO., LTD., Suwon-si (KR)

(21) Appl. No.: 19/644,698

(22) Filed: Apr. 10, 2026

Related U.S. Application Data
(63) Continuation of application No. PCT/KR2026/001756, filed on Jan. 29, 2026.

(30) Foreign Application Priority Data
Feb. 10, 2025 (KR) 10-2025-0016883

(51) Int. Cl. G06T 11/00; G06F 3/01; G06V 10/70; G06V 20/17; G06V 20/20; G06V 40/18; G06V 40/20

(52) U.S. Cl. CPC G06T 11/00; G06F 3/013; G06F 3/017; G06V 10/768; G06V 20/17; G06V 20/20; G06V 40/18; G06T 2200/24; G06V 40/28

(57) ABSTRACT

An electronic apparatus includes: an aerial imaging display including: an image module configured to form an original image to be provided in mid-air and transmit light for the original image; and a floating module configured to provide a floating image by forming a real image of the original image at a preset position in mid-air through the light for the original image; a communication interface; a camera; memory storing instructions; and at least one processor, wherein the instructions, when executed by the at least one processor, cause the electronic apparatus to: obtain an image through the camera; based on recognizing a user through the image, receive context information of an external apparatus from the external apparatus through the communication interface; obtain information related to the context information of the external apparatus; and provide a floating image including the information related to the context information through the aerial imaging display.

### CROSS-REFERENCE TO RELATED APPLICATIONS

This application is a continuation application of International Application No. PCT/KR2026/001756, filed on January 29, 2026, which is based on and claims priority to Korean Patent Application No. 10-2025-0016883, filed on February 10, 2025, in the Korean Intellectual Property Office, the disclosures of which are incorporated by reference herein in their entireties.

### BACKGROUND

### 1. Field

The present disclosure relates to an electronic apparatus and a controlling method thereof and more particularly, to an electronic apparatus for providing a floating image including various information in association with an external apparatus and a controlling method thereof.

### 2. Description Of Related Art

Electronic apparatuses including various types of displays have been developed. In particular, an electronic apparatuses that allows a floating image to be viewed in mid-air at a certain distance from a display panel has been developed.

In addition, recently, demand for augmented reality (AR) and virtual reality (VR) markets has been increasing, and with growing attention to public hygiene, there is an increasing need for electronic apparatuses capable of non-contact interaction.

The above-described information may be provided as related art for the purpose of facilitating understanding of the present disclosure. Nothing in the foregoing shall be construed as a statement or determination that any of the above constitutes prior art relevant to the present disclosure.

### SUMMARY

According to an aspect of the disclosure, an electronic apparatus includes: an aerial imaging display including: an image module configured to form an original image to be provided in mid-air and transmit light for the original image; and a floating module configured to provide a floating image by forming a real image of the original image at a preset position in mid-air through the light for the original image; a communication interface; a camera; memory storing instructions; and at least one processor, wherein the instructions, when executed by the at least one processor individually or collectively, cause the electronic apparatus to: obtain an image through the camera; based on recognizing a user through the image, receive context information of an external apparatus from the external apparatus through the communication interface; obtain information related to the context information of the external apparatus; and provide a floating image including the information related to the context information through the aerial imaging display.

The context information may include state information of the external apparatus, and the instructions, when executed by the at least one processor individually or collectively, may further cause the electronic apparatus to: based on identifying that the external apparatus is in an off state based on the state information of the external apparatus, obtain information about a greeting screen; based on identifying that the external apparatus is in a state of displaying a daily board based on the state information of the external apparatus, obtain private information of the user; based on identifying that the external apparatus is in a state of displaying an art image based on the state information of the external apparatus, obtain information about the art image; and based on identifying that the external apparatus is in a state of displaying content based on the state information of the external apparatus, obtain information about an avatar user interface (UI).

The context information may include information about content provided by the external apparatus, and the instructions, when executed by the at least one processor individually or collectively, may further cause the electronic apparatus to: provide a floating image including an avatar user interface (UI) through the aerial imaging display; and provide a (i) conversation affordance on the avatar UI or (ii) an emotional expression on the avatar UI, based on the information about the content received from the external apparatus.

The instructions, when executed by the at least one processor individually or collectively, may further cause the electronic apparatus to: provide a floating image including a content list that includes a plurality of contents through the aerial imaging display; based on detecting a gesture for scrolling the content list, scroll the content list in the floating image; and based on detecting a gesture for selecting a content of the plurality of contents in the content list, provide a floating image including the selected content through the aerial imaging display.

The context information may include notification information, and the instructions, when executed by the at least one processor individually or collectively, may further cause the electronic apparatus to: provide a floating image including a notification icon corresponding to the notification information; and based on identifying that the user is gazing at the aerial imaging display through the camera, provide a floating image including the notification information.

The instructions, when executed by the at least one processor individually or collectively, may further cause the electronic apparatus to: based on recognizing the user through the image, request user information from a wearable device worn by the user through the communication interface; and authenticate the user based on the user information received from the wearable device.

The instructions, when executed by the at least one processor individually or collectively, may further cause the electronic apparatus to: based detecting a gesture for selecting a user interface (UI) element in the floating image after the user is authenticated, identify whether the UI element has an interaction; and based on identifying that the UI element has an interaction, generate information about a vibration pattern and transmit the information about the vibration pattern to the wearable device.

The instructions, when executed by the at least one processor individually or collectively, may further cause the electronic apparatus to: based on recognizing that the external apparatus is provided at the electronic apparatus using an image obtained through the camera, identify whether the external apparatus is disposed at a preset position; based on identifying that the external apparatus is disposed at the preset position, provide a floating image including augmented information around the external apparatus; and based on identifying that the external apparatus is not disposed at the preset position, provide a floating image including an affordance for adjusting a position of the external apparatus around the external apparatus.

The instructions, when executed by the at least one processor individually or collectively, may further cause the electronic apparatus to: based on detecting a gesture for controlling the augmented information in the floating image, update the augmented information based on the gesture; and transmit information about the updated augmented information to the external apparatus through the communication interface.

The instructions, when executed by the at least one processor individually or collectively, may further cause the electronic apparatus to: based on receiving information for updating augmented information from the external apparatus, update the augmented information based on the received information.

According to an aspect of the disclosure, a method of controlling an electronic apparatus including an aerial imaging display and a camera, the aerial imaging display being configured to form an original image to be provided in mid-air, transmit light for the original image, and provide a floating image by forming a real image of the original image at a preset position in mid-air through the light for the original image, includes: obtaining an image through the camera; based on recognizing a user through the image, receiving context information of an external apparatus from the external apparatus; obtaining information related to the context information of the external apparatus; and providing a floating image including the information related to the context information through the aerial imaging display.

The context information may include state information of the external apparatus, and wherein the obtaining the information related to the context information may include: based on identifying that the external apparatus is in an off state based on the state information of the external apparatus, obtaining information about a greeting screen; based on identifying that the external apparatus is in a state of displaying a daily board based on the state information of the external apparatus, obtaining private information of the user; based on identifying that the external apparatus is in a state of displaying an art image based on the state information of the external apparatus, obtaining information about the art image; and based on identifying that the external apparatus is in a state of displaying content based on the state information of the external apparatus, obtaining information about an avatar user interface (UI).

The context information may include information about content provided by the external apparatus, the providing may include providing a floating image including an avatar user interface (UI), and the method may further include providing (i) a conversation affordance on the avatar UI or (ii) an emotional expression on the avatar UI, based on the information about the content received from the external apparatus.

The providing a floating image may include providing a floating image including a content list that includes a plurality of contents through the aerial imaging display, and the method may further include: based on detecting a gesture for scrolling the content list in the floating image, scrolling the content list in the floating image; and based on detecting a gesture for selecting a content of the plurality of contents in the content list, providing a floating image including the selected content through the aerial imaging display.

The context information may include notification information, and the providing the floating image includes: providing a floating image including a notification icon corresponding to the notification information; and based on identifying that the user is gazing at the aerial imaging display through the camera, providing a floating image including the notification information.

The method may further include: based on recognizing the user through the image, requesting user information from a wearable device worn by the user, and authenticating the user based on the user information received from the wearable device.

The method may further include: based detecting a gesture for selecting a user interface (UI) element in the floating image after the user is authenticated, identifying whether the UI element has an interaction; and based on identifying that the UI element has the interaction, generating information about a vibration pattern and transmitting the information about the vibration pattern to the wearable device.

The method may further include: based on recognizing that the external apparatus is provided at the electronic apparatus using an image obtained through the camera, identifying whether the external apparatus is disposed at a preset position; based on identifying that the external apparatus is disposed at the preset position, providing a floating image including augmented information around the external apparatus; and based on identifying that the external apparatus is not disposed at the preset position, providing a floating image including an affordance for adjusting a position of the external apparatus around the external apparatus.

The method may further include: based on detecting a gesture for controlling the augmented information in the floating image, updating the augmented information based on the gesture; and transmitting information about the updated augmented information to the external apparatus.

The method may further include, based on receiving information for updating the augmented information from the external apparatus, updating the augmented information based on the received information.

### BRIEF DESCRIPTION OF THE DRAWINGS

The above and other aspects, features, and advantages of certain embodiments of the present disclosure will be more apparent from the following description taken in conjunction with the accompanying drawings, in which:

With respect to the description of the drawings, the same or similar reference numerals may be used for the same or similar components.

FIG. 1 is a block diagram illustrating configuration of an electronic apparatus according to an embodiment;

FIGS. 2A and 2B are views provided to explain an aerial imaging display for providing a floating image according to an embodiment;

FIG. 3 is a view provided to explain a camera according to an embodiment;

FIG. 4 is a sequence view provided to explain an embodiment in which an operation is performed in association with a wearable device according to an embodiment;

FIG. 5 is a sequence view and FIGS. 6A, 6B, 6C, and FIG. 6D are views provided to explain an embodiment in which a floating image is provided in association with an external apparatus according to an embodiment;

FIG. 7 is a flowchart and FIGS. 8A, 8B, 8C, and FIG. 8D are views provided to explain an embodiment in which an avatar UI is controlled according to content provided by an external apparatus according to an embodiment;

FIG. 9 is a flowchart and FIG. 10 are is a view provided to explain an embodiment in which a floating image including content is provided by providing a content list according to an embodiment;

FIG. 11 is a flowchart and FIGS. 12A and 12B are views provided to explain an embodiment in which notification information received from an external apparatus is provided according to an embodiment;

FIG. 13 is a flowchart and FIGS. 14A and 14B are views provided to explain an embodiment in which augmented information is provided when an external apparatus is positioned on an electronic apparatus according to an embodiment; and

FIG. 15 is a flowchart provided to explain a method of controlling an electronic apparatus that provides a floating image according to an embodiment.

### DETAILED DESCRIPTION

Various embodiments in this disclosure and the terms used herein do not limit the technical features in this disclosure to specific embodiments, but should be understood to include various modifications, equivalents or alternatives of the corresponding embodiments.

With respect to the description of the drawings, similar components may be denoted by similar reference numerals.

The singular form of a noun corresponding to an item may include one item or a plurality of items, unless the relevant context clearly indicates otherwise.

In this disclosure, “A or B”, “at least one of A and B”, “at least one of A or B”, “A, B or C”, “at least one of A, B and C”, and “at least one of A, B, or C” may each include any one of the items listed together in the corresponding phrase, or any possible combination thereof. For example, the term “A or B”, “at least one of A and B”, or “at least one of A or B” may refer to all of the case (1) where only A is included, the case (2) where only B is included, or the case (3) where both of A and B are included.

Terms “first”, “second”, “1^{st},” or “2^{nd},” may be used simply to distinguish the corresponding component from other corresponding components, and may limit the corresponding components in other aspects (e.g. : importance or order).

When it is mentioned that one (e.g., first) component is “coupled” or “connected” to another (e.g., second) component, with or without the terms “functionally” or “communicatively”, it means that the component can be connected to another component directly (e.g. wired), wirelessly, or through a third component.

Terms such as “have” or “include” are intended to designate the presence of features, numbers, steps, operations, components, parts, or a combination thereof described in this disclosure, but are not intended to exclude the presence or addition of one or more other features, numbers, steps, operations, components, parts, or a combination thereof in advance.

When a component is said to be “connected,” “coupled,” “supported,” or “in contact” with another component, this means not only when the components are directly connected, coupled, supported, or in contact, but also when they are indirectly connected, coupled, supported, or in contact through a third component.

When a component is said to be located “on” another component, this includes not only a case where a component is in contact with another component, but also a case where another component exists between the two components.

The term “and/or” includes a combination of a plurality of related elements described herein or any element of a plurality of related elements described herein.

In some cases, an expression “~an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor (not shown) except for a ‘module’ or a ‘unit’ that needs to be implemented as specific hardware.

Meanwhile, various elements and regions in the drawings are schematically drawn in the drawings. Therefore, the technical concept of the disclosure is not limited by a relative size or spacing drawn in the accompanying drawings.

Hereinafter, an embodiment according to the present disclosure will be described in detail with reference to the accompanying drawings.

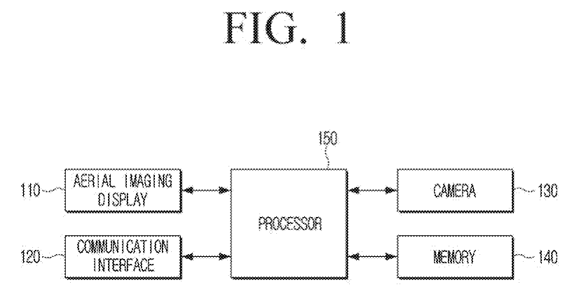

FIG. 1 is a block diagram illustrating configuration of an electronic apparatus according to an embodiment. An electronic apparatus 100 according to various embodiments may include, as shown in FIG. 1, an aerial imaging display 110, a communication interface 120, a camera 130, memory 140, and at least one processor 150 (also referred to herein as “the processor”). According to an embodiment, the electronic apparatus 100 may be an electronic apparatus including a table-type display for providing a floating image, but is not limited thereto. In addition, the configuration shown in FIG. 1 is merely one embodiment, and various components and configurations may be added or deleted depending on the type of electronic apparatus 100.

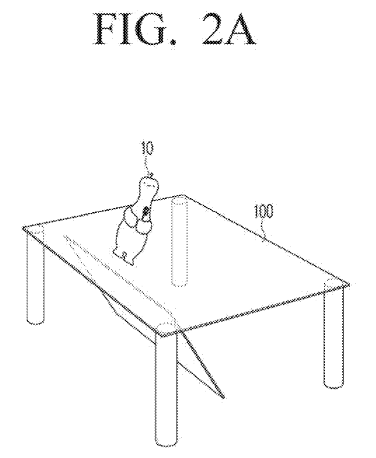

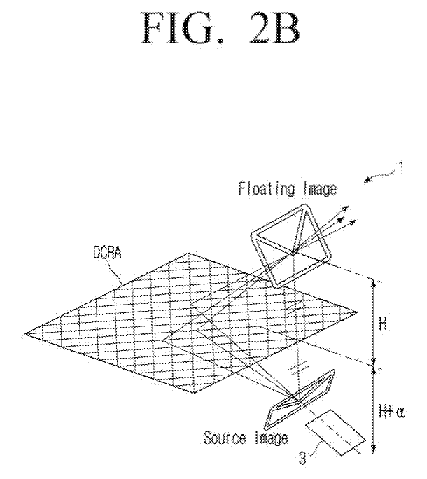

The aerial imaging display (AID) 110 may form a real image at a preset position in mid-air to provide a floating image. Here, the floating image may refer to an image that appears to float in mid-air in a three-dimensional space without being fixed to a physical screen or background, and may be referred to as various terms such as holographic image, three-dimensional image, virtual image, or aerial image. In one or more embodiments, the aerial imaging display 110 may be implemented as a table-type display, as shown in FIG. 2A. The aerial imaging display 110 may be referred to as various terms such as floating image display or hologram display.

In particular, referring to the aerial imaging display 110 of FIG. 2B, a dihedral corner reflector array (DCRA) is used to form a floating image. Light carrying an original image is reflected twice by the DCRA and then converges at the opposite side of the DCRA, forming a floating image. In this case, the position at which the floating image is formed is a position away from the DCRA by a distance equal to the distance between the DCRA and the original image; in other words, the height H at which the floating image is formed is equal to the vertical distance from the DCRA to the original image. Further, since the floating image should be displayed in mid-air in an oblique direction relative to the DCRA, an image forming unit 3 may be disposed such that the original image is formed in a symmetrically oblique direction.

The aerial imaging display 110 may include an imaging module configured to form the original image to be provided in mid-air and to transmit light for the original image, and a floating module configured to form a real image of the original image at a preset position in mid-air through the light for the original image to provide a floating image.

Specifically, the imaging module forms the original image to be displayed in mid-air, and transmits light for the original image to the floating module. The imaging module may include an image forming unit, and may further include a collimating optical unit. The floating module is configured to use an array of a plurality of corner reflectors to form a real image of the original image at a preset position in mid-air. According to one or more embodiments, the floating module includes a holographic optical element. In addition, the floating module may include a waveguide that guides light for the original image to output it to a different position, a holographic optical element including an angle-selective hologram, and a floating element in which a plurality of corner reflectors are arrayed. Further, the floating module may further include magnifying optics.

Accordingly, the aerial imaging display 110 may provide a floating image including various information. For example, the aerial imaging display 110 may provide a floating image including an avatar UI. The floating image provided according to the present disclosure will be described in detail with reference to drawings hereinafter.

The communication interface 120 includes at least one circuit, and may perform communication with various types of external apparatuses or servers. The communication interface 120 may include at least one of a Bluetooth Low Energy (BLE) module, a Wi-Fi communication module, a cellular communication module, a third generation (3G) mobile communication module, a fourth generation (4G) mobile communication module, a 4G Long Term Evolution (LTE) communication module, or a fifth generation (5G) mobile communication module.

According to one or more embodiments, the communication interface 120 may perform communication with a wearable device worn by a user or an external apparatus (e.g., TV, laptop, monitor, etc.) using a short-range wireless communication module to transmit and receive various information.

According to one or more embodiments, the communication interface 120 may receive context information of an external apparatus from the external apparatus. Here, the context information refers to information describing specific data, state, environment, or usage scenario associated with the external apparatus, and for example, may include identification information of the external apparatus, communication connection information of the external apparatus, user account information of the external apparatus, state information of the external apparatus, information about content provided by the external apparatus, notification information obtained by the external apparatus, etc.

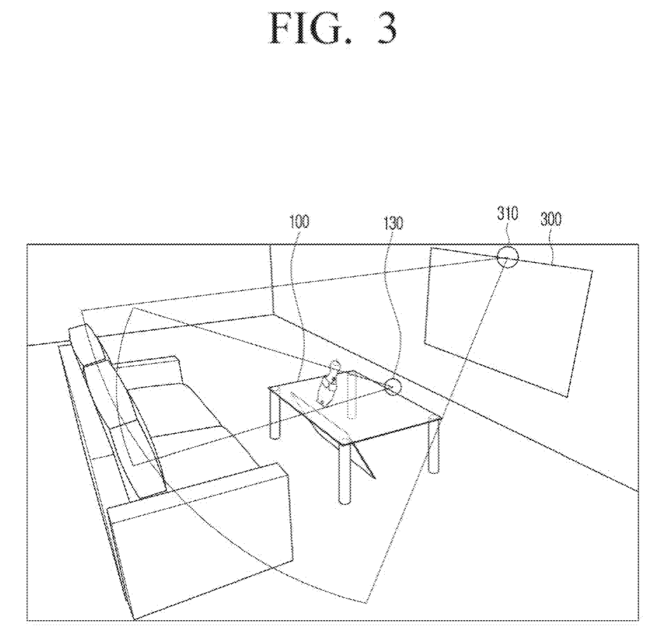

The camera 130 may capture still images and moving images. The camera 130 according to various embodiments may include one or more lenses, an image sensor, an image signal processor, and a flash. One or more lenses may include a telephoto lens, a wide-angle lens, and/or a super wide-angle lens disposed on a surface of the electronic apparatus 100, and may include a three-dimensional depth lens. According to one or more embodiments, as shown in FIG. 3, the camera 130 may be disposed on one area of the electronic apparatus 100 to capture a user seated on a sofa. Accordingly, the electronic apparatus 100 may detect a user gesture (particularly, hand gestures) captured by the camera 130 to control various functions of the electronic apparatus 100. In addition, the electronic apparatus 100 may analyze user gaze through an image captured by the camera 130 to obtain information about the user gaze. The camera 130 may be disposed on one area of the electronic apparatus 100, but is not limited thereto, and various embodiments according to the present disclosure may be implemented through connection with a camera existing separately outside the electronic apparatus 100.

Further, the electronic apparatus 100 may receive an image captured by the camera 130 positioned at an external apparatus 300 and obtain information about a user or an object.

The memory 140 may store an operating system (OS) for controlling the overall operations of components of the electronic apparatus 100, as well as instructions or data related to the components of the electronic apparatus 100. In particular, the memory 140 may include a plurality of modules (e.g., a plurality of modules shown in FIG. 2) for providing a floating image. In particular, when a function for providing a floating image is executed, the electronic apparatus 100 may load data for performing various operations of multiple modules stored in non-volatile memory into volatile memory. Here, loading refers to an operation of retrieving and storing data stored in the non-volatile memory into the volatile memory so that the processor 150 can access it.

The memory 140 may be implemented as non-volatile memory (e.g., hard disk, Solid State Drive (SSD), flash memory), volatile memory (e.g., memory within the processor 150), or the like.

The processor 150 may control the electronic apparatus 100 according to at least one instruction stored in the memory 140.

In particular, the one or more processors 150 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 150 may control one or any combination of the other components of the electronic apparatus, and may perform communication-related operations or data processing. The one or more processors 150 may execute one or more programs or instructions stored in the memory 140. For example, the one or more processors 150 may perform a method according to an embodiment by executing one or more instructions stored in the memory 140.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 150 may be implemented as a single core processor including a single core, or as one or more multicore processors including a plurality of cores (e.g., homogeneous multicore or heterogeneous multicore). When the one or more processors 150 are implemented as a multicore processor, each of the plurality of cores included in the multicore processor may include internal memory, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor 150 may be a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure.

In particular, the processor 150, by executing at least one instruction, obtains an image through the camera 130, and when a user is recognized through the image, receives context information of an external apparatus from the external apparatus through the communication interface 120, obtains information related to the received context information of the external apparatus, and provides a floating image including the obtained information through the aerial imaging display 110.

According to one or more embodiments, the context information may include state information of the external apparatus. Here, when it is identified that the external apparatus is in an off state, the processor 150 may obtain information for a greeting screen; when it is identified that the external apparatus is in a state of displaying a daily board, obtain private information of the user; when it is identified that the external apparatus is in a state of displaying an art image, obtain information about the art image; and when it is identified that the external apparatus is in a state of displaying content, obtain information about an avatar UI.

According to one or more embodiments, the context information may include information about content provided by the external apparatus. Here, the processor 150 may provide a floating image including an avatar user interface (UI) through the aerial imaging display 110, and based on the information about content received from the external apparatus, may provide a conversation affordance on the avatar UI or provide emotional expressions using the avatar UI.

According to one or more embodiments, the processor 150 may provide a floating image including a content list through the aerial imaging display 110, when a gesture for scrolling the content list is detected, scroll the content list included in the floating image, and when a gesture for selecting one of a plurality of content included in the content list is detected, a floating image including the selected content may be provided through the aerial imaging display 110.

According to one or more embodiments, the context information may include notification information. Here, the processor 150 may provide a floating image including a notification icon corresponding to the notification information, and when it is identified that the user is gazing at the aerial imaging display 110 through the camera 130, may provide a floating image including the notification information.

According to one or more embodiments, when a user is recognized through the image, the processor 150 may request user information from a wearable device worn by the user through the communication interface 120, and may authenticate the user based on the user information received from the wearable device.

According to one or more embodiments, when a gesture for selecting a UI element included in the floating image is detected after the user is authenticated, the processor 150 may identify whether the UI element is a UI element having an interaction, and when it is identified that the UI element is a UI element having an interaction, may generate information about a vibration pattern and transmit it to the wearable device.

According to one or more embodiments, when it is recognized that an external apparatus is positioned on the electronic apparatus 100 using an image captured through the camera 130, the processor 150 may identify whether the external apparatus is disposed at a preset position, when it is identified that the external apparatus is disposed at the preset position, provide a floating image including augmented information around the external apparatus, and when it is identified that the external apparatus is not disposed at the preset position, provide a floating image including an affordances for adjusting the position of the external apparatus around the external apparatus.

According to one or more embodiments, when a gesture for controlling the augmented information included in the floating image is detected, the processor 150 may update the augmented information based on the gesture, and may transmit information about the updated augmented information to the external apparatus through the communication interface.

According to one or more embodiments, when information for updating the augmented information is received from the external apparatus, the processor 150 may update the augmented information based on the received information.

In addition to the configuration shown in FIG. 1, the electronic apparatus 100 may further include various configurations such as a microphone for receiving a user voice, a plurality of sensors for detecting the external environment, and an input/output interface.

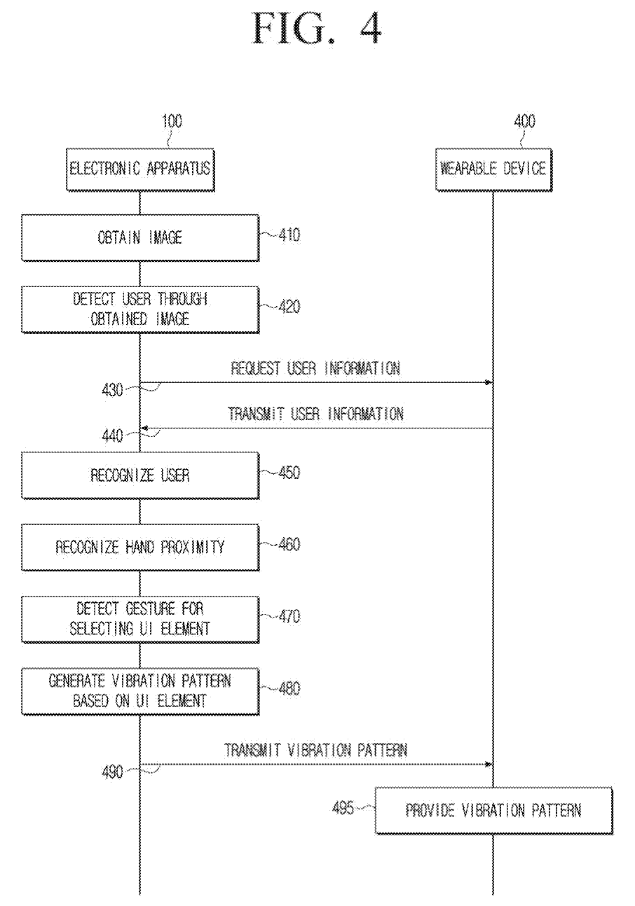

FIG. 4 is a sequence view provided to explain an embodiment in which an operation is performed in association with a wearable device according to an embodiment. Here, the wearable device 400 is a device worn by a user, and may be a smart watch. However, embodiments are not limited thereto, and may be implemented as various wearable devices such as a smart ring, smart glasses, and the like.

The electronic apparatus 100 may obtain an image (410). Here, the electronic apparatus 100 may obtain the image through a camera 130 of the electronic apparatus 100. However, this is merely an example embodiment, and the electronic apparatus 100 may obtain an image captured by the external apparatus 300 through the communication interface 120.

The electronic apparatus 100 may detect a user through the obtained image (420). In particular, the electronic apparatus 100 may detect whether the user is located at a preset position (e.g., a sofa located around the electronic apparatus 100) by analyzing the image.

The electronic apparatus 100 may request user information from the wearable device 400 (430). Here, the electronic apparatus 100 may request user information using a broadcasting method. However, this is merely an example embodiment, and the electronic apparatus 100 may request user information using a previously connected communication method. Here, the user information may be account information of the user; however, this is merely one embodiment, and various types of information such as image information of the user may be included.

The wearable device 400 may transmit the user information to the electronic apparatus 100 (440).

The electronic apparatus 100 may recognize the user (450). According to one or more embodiments, the electronic apparatus 100 may identify whether the user included in the image is a pre-registered user based on the user information. In other words, when the account information of the user received from the wearable device 400 matches the account information of the pre-registered user, the electronic apparatus 100 may recognize the user.

The electronic apparatus 100 may recognize hand proximity (460). Here, the hand proximity may mean that the user’s hand moves toward the electronic apparatus 100 and is located within a preset distance from the electronic apparatus 100. According to one or more embodiments, the electronic apparatus 100 may recognize the hand proximity of the user by analyzing an image captured through the camera 130. According to one or more embodiments, the electronic apparatus 100 may recognize hand proximity based on a sensing value received from the wearable device 400. When hand proximity is recognized, the electronic apparatus 100 may provide a floating image including a UI element. However, this is merely one embodiment, and the electronic apparatus 100 may provide a floating image including a UI element beforehand proximity is recognized, and may provide a cursor or the like for selecting the UI element after hand proximity is recognized.

The electronic apparatus 100 may detect a gesture for selecting a UI element (470). According to one or more embodiments, when a preset gesture (e.g., a double-tap gesture or a fist-clenching gesture, etc.) is detected while a highlight is displayed on the UI element, the electronic apparatus 100 may detect a gesture for selecting the UI element. Here, the electronic apparatus 100 may detect the gesture by analyzing an image captured through the camera 130. However, this is merely an example embodiment, and the gesture may be detected based on a sensing value received from the wearable device 400.

According to one or more embodiments, the electronic apparatus 100 may execute a function corresponding to the UI element. For example, when the UI element is an item corresponding to content, the electronic apparatus 100 may provide a floating image including the content corresponding to the UI element.

The electronic apparatus 100 may generate a vibration pattern based on the UI element (480). According to one or more embodiments, the electronic apparatus 100 may generate a vibration pattern based on the type of the UI element. For example, when the UI element is an object capable of performing an interaction, such as a button or an avatar UI, the electronic apparatus 100 may generate a vibration pattern corresponding to the UI element. In one embodiment, the electronic apparatus 100 may generate different types of vibration patterns depending on the UI element. For example, in the case of a first type of UI element, the electronic apparatus 100 may generate a first vibration pattern, and in the case of a second type of UI element, the electronic apparatus 100 may generate a second vibration pattern different from the first vibration pattern. Here, the vibration patterns may include various information such as vibration intensity, vibration duration, vibration cycle, etc.

According to one or more embodiments, in the case of an avatar UI capable of performing an emotional interaction, the electronic apparatus 100 may provide a vibration pattern corresponding to the emotional expression (e.g., emotions such as surprise or delight, etc.) provided by the avatar UI through a touch gesture.

The electronic apparatus 100 may transmit information about the generated vibration pattern to the wearable device 400 (490).

The wearable device 400 may provide a vibration pattern based on information about the vibration pattern received from the electronic apparatus 100 (495).

Accordingly, the electronic apparatus 100 may recognize a user through the wearable device 400 worn by the user, and the user may be provided with feedback based on the interaction with the electronic apparatus 100 through the vibration pattern, thereby enabling more vivid and intuitive control of the electronic apparatus 100.

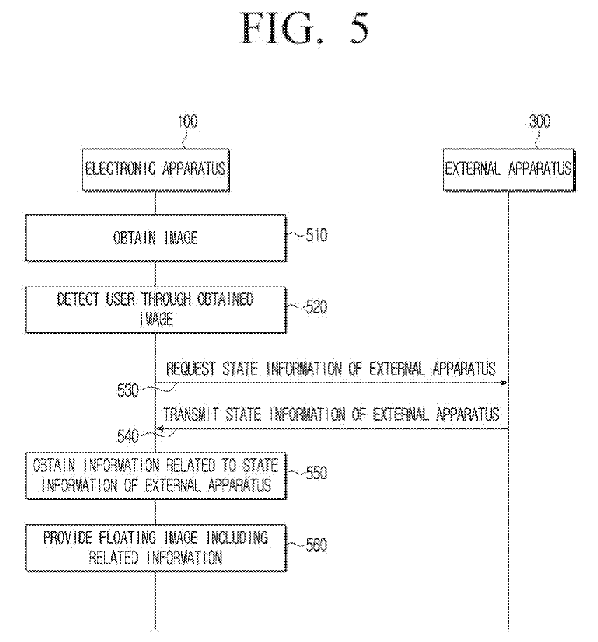

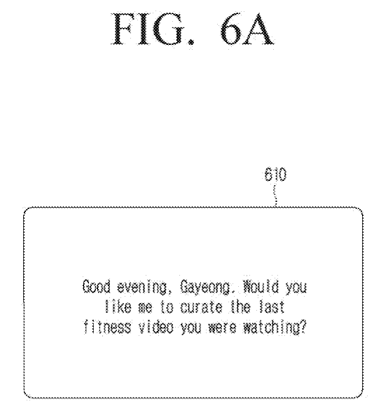

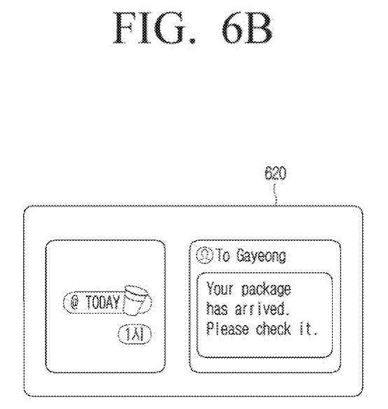

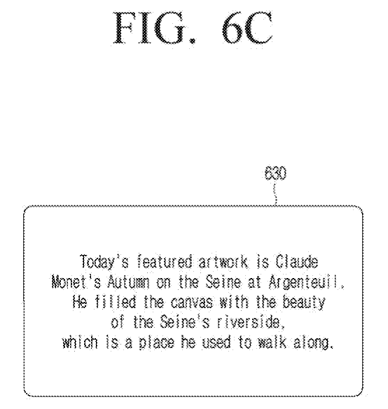

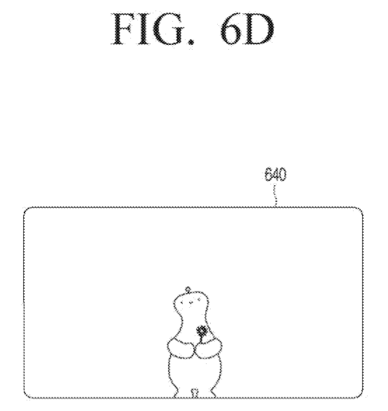

FIG. 5 is a sequence view provided to explain an embodiment in which a floating image is provided in association with an external apparatus according to an embodiment. Here, the external apparatus 300 refers to a device located outside the electronic apparatus 100 and is capable of providing content, and may be, for example, a TV, but is not limited thereto, and may be implemented as a user terminal apparatus such as notebook PC, desktop PC, tablet PC, as a home appliance such as refrigerator, washing machine, or as a device such as an AI speaker.

The electronic apparatus 100 may obtain an image (510). Here, the electronic apparatus 100 may obtain an image through the camera 130 of the electronic apparatus 100, but this is merely one embodiment, and the electronic apparatus 100 may obtain an image captured by the external apparatus 300 through the communication interface 120.

The electronic apparatus 100 may detect a user through the obtained image (520). In particular, the electronic apparatus 100 may analyze the image to detect whether the user is located at a preset position (e.g., a sofa positioned around the electronic apparatus 100).

The electronic apparatus 100 may request state information of the external apparatus 300 from the external apparatus 300 (530). Here, the state information of the external apparatus 300 may include the current operating state of the external apparatus, the screen state displayed by the external apparatus, and the setting state of the external apparatus, but is not limited thereto.

The external apparatus 300 may transmit the state information of the external apparatus 300 to the electronic apparatus 100 in response to the request (540).

The electronic apparatus 100 may obtain information related to the state information of the external apparatus 300 based on the state information of the external apparatus 300 (550). According to one or more embodiments, when it is identified that the external apparatus 300 is in an off state based on the state information of the external apparatus 300, the electronic apparatus 100 may obtain information about a greeting screen. Here, the greeting screen refers to an initial interface provided to the user when the electronic apparatus 100 is activated or booted, and may include information for guiding the initial setup of the electronic apparatus 100, basic information about the electronic apparatus 100, or previous usage information.

According to one or more embodiments, when it is identified that the external apparatus 300 is in a state of displaying a daily board based on the state information of the external apparatus 300, the electronic apparatus 100 may obtain the user’s private information. Here, the daily board refers to a personalized dashboard of the user, and may include information that the user frequently checks in daily life. The user’s private information may include the user’s schedule information, preference information, setting information, and so on.

According to one or more embodiments, when it is identified that the external apparatus 300 is in a state of displaying an art image based on the state information of the external apparatus 300, the electronic apparatus 100 may obtain information about the art image. Here, the state in which the external apparatus 300 is displaying the art image may be referred to as art mode, gallery mode, screen saver mode, etc. The information about the art image may include a title of the art image, an artist of the art image, and detailed information about the art image.

According to one or more embodiments, when it is identified that the external apparatus 300 is in a state of displaying content based on the state information of the external apparatus 300, the electronic apparatus 100 may obtain information about an avatar UI. Here, the avatar UI is a UI element capable of performing an interaction with the user, and may be referred to as character UI, virtual agent UI, persona UI, or the like. The user may perform an interaction with the avatar UI while watching content through the avatar UI and receive various user experiences. Meanwhile, the electronic apparatus 100 may obtain not only information about the avatar UI but also information about the content currently displayed. For example, various information such as the title, characters, director, playback time, storyline, etc. of the content currently played may be obtained.

The electronic apparatus 100 may provide a floating image including relevant information (560). According to one or more embodiments, when it is identified that the external apparatus 300 is in an off state based on state information of the external apparatus 300, the electronic apparatus 100 may provide a floating image 610 including a greeting screen for guiding previous usage information of the user and a function the user currently intends to perform, as shown in FIG. 6A.

According to one or more embodiments, when it is identified that the external apparatus 300 is in a state of displaying a daily board based on the state information of the external apparatus 300, the electronic apparatus 100 may provide a floating image 620 including the user’s schedule information and message information, as shown in FIG. 6B.

According to one or more embodiments, when it is identified that the external apparatus 300 is in a state of displaying an art image based on the state information of the external apparatus 300, the electronic apparatus 100 may provide a floating image 630 including information about the artist of the currently displayed art image and detailed information, as shown in FIG. 6C.

According to one or more embodiments, when it is identified that the external apparatus 300 is in a state of displaying content based on the state information of the external apparatus 300, the electronic apparatus 100 may provide a floating image 640 including an avatar UI capable of performing an interaction with the user, as shown in FIG. 6D.

In the above-described embodiment, it is explained that when the external apparatus 300 displays content, an avatar UI is displayed. However, this is merely an example embodiment, and the electronic apparatus 100 may provide a floating image including the avatar UI when a preset trigger voice is received. For example, when a preset trigger voice, “Eli” is detected, the electronic apparatus 100 may provide the floating image 640 including the avatar UI capable of performing an interaction with the user, as illustrated in FIG. 6D. The electronic apparatus 100 may provide various functions of the electronic apparatus 100 through the avatar UI while the avatar UI is being displayed. For example, the electronic apparatus 100 may change currently displayed content or art image through a user voice or gesture, and the avatar UI may provide information about the changed content or art image. Accordingly, the user may control various functions of the electronic apparatus 100 while performing an interaction with a virtual avatar, and thus be provided with a new user experience.

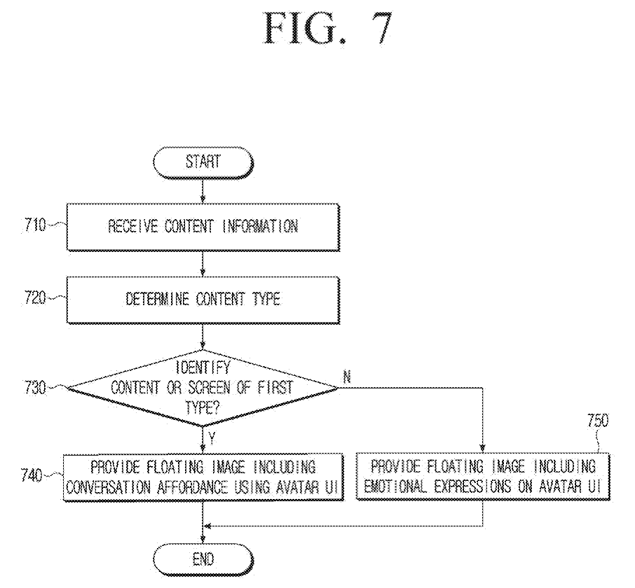

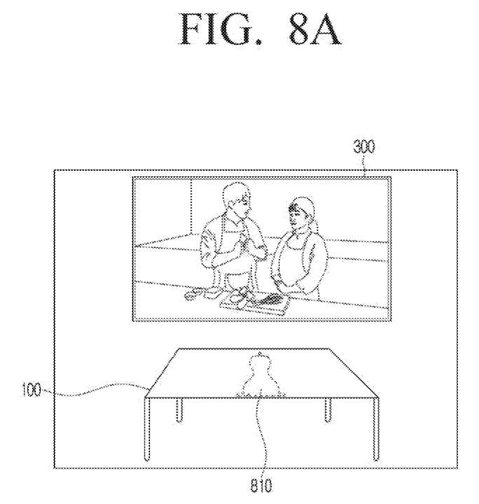

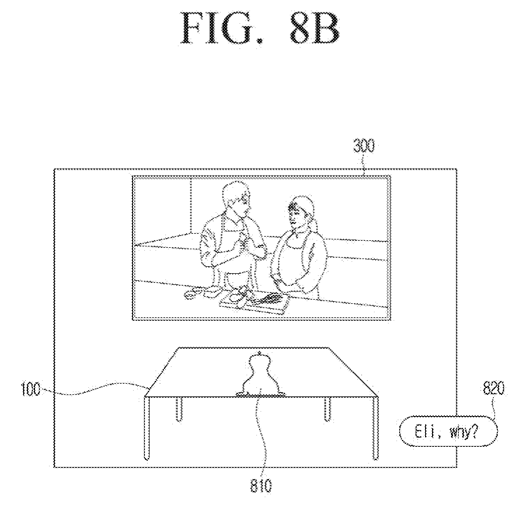

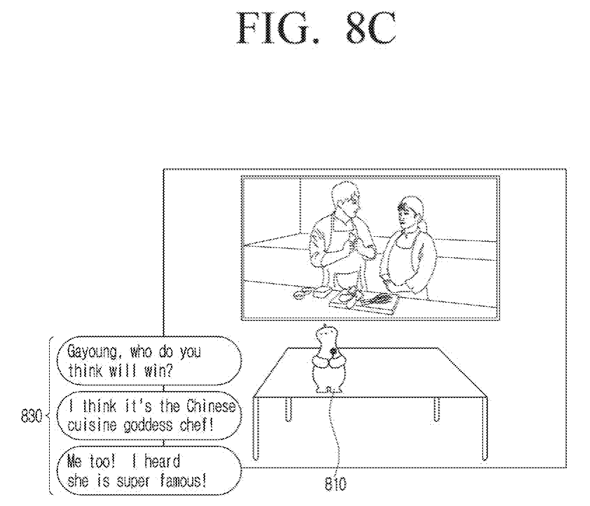

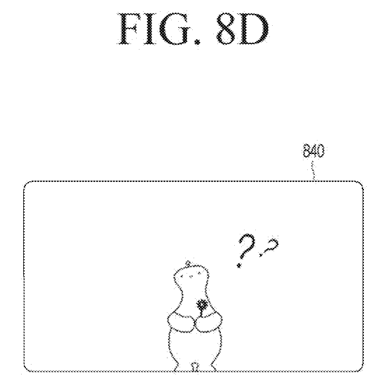

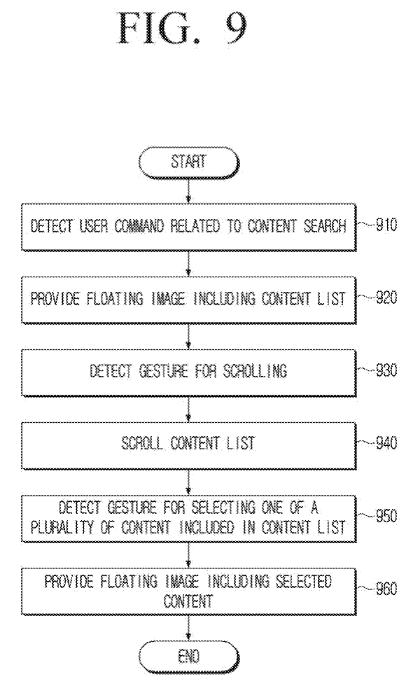

FIG. 7 is a flowchart and FIGS. 8A to 8D are views provided to explain an embodiment in which an avatar UI is controlled according to content provided by an external apparatus according to an embodiment. According to an embodiment of the present disclosure, the external apparatus 300 may be in a state of providing content.

The electronic apparatus 100 may receive content information (710). Here, the content information may include identification information of the content, information about the current screen being displayed by the content, and a captured image of the currently displayed screen.

The electronic apparatus 100 may determine the type of content (or screen) based on the content information (720). Here, the type of content (or screen) may include a first type and a second type, and the content (or screen) of the first type may be content or a screen capable of engaging in conversation with an avatar UI. The content (or screen) of the second type may be content or a screen for providing emotional expressions.

When it is identified as content or a screen of the first type (730-Y), the electronic apparatus 100 may provide a floating image including a conversation affordance using an avatar UI (740). Here, the conversation affordance is a UI element intended to intuitively guide a user to understand a conversation situation by looking at an interface element, and may be referred to as various terms such as a conversation-prompting UI element, a conversation guide UI element, etc.

According to an embodiment, as shown in FIG. 8A, while the external apparatus 300 is displaying content, the electronic apparatus 100 may provide a floating image including an avatar UI 810 of a first brightness. In this case, when the content (or screen) displayed by the external apparatus 300 is recognized as content or a screen of the first type, the electronic apparatus 100 may provide a conversation affordance that changes the brightness of the avatar UI 810 from the first brightness to a second brightness, as shown in FIG. 8B. In other words, the electronic apparatus 100 may provide a conversation affordance in which the avatar UI 810 becomes gradually activated to induce the user’s participation in the conversation. Accordingly, the user may initiate a conversation by uttering a user voice 820 such as “Eli, why?”

Also, as shown in FIG. 8C, the electronic apparatus 100 may perform a conversation 830 with the user using the activated avatar UI 810. For example, the electronic apparatus 100 may provide a question such as “Gayeong, who do you think will win?” through the avatar UI 810, and when a response such as “I think it’s the Chinese cuisine goddess chef” is received from the user, the electronic apparatus 100 may provide a response such as “Me too~ She’s really famous!” The user may recognize the conversation affordance as shown in FIGS. 8A and 8B, and perform the conversation 830 with the electronic apparatus 100, as shown in FIG. 8C.

When it is identified that the content or screen is not of the first type (730-N) (i.e., when content or a screen of a second type is identified), the electronic apparatus 100 may provide a floating image including an emotional expression on an avatar UI (740). Here, the electronic apparatus 100 may express an emotion corresponding to the current content or screen by using the avatar UI. For example, when the currently displayed content screen is a quiz show screen, the electronic apparatus 100 may provide an expression of curiosity by using an avatar UI 840, as illustrated in FIG. 8D. As another example, when the currently displayed content screen is a sad screen, the electronic apparatus 100 may express a sad emotion by using the avatar UI.

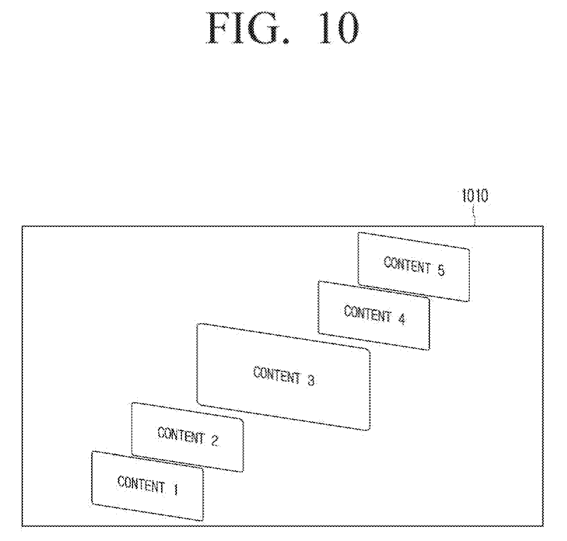

FIG. 9 is a flowchart and FIG. 10 is a view provided to explain an embodiment in which a floating image including content is provided by providing a content list according to an embodiment.

The electronic apparatus 100 may detect a user command related to content search (910). Here, the user command related to content search is a user command for generating a content list, and may be obtained through a gesture, a user voice, or the like.

The electronic apparatus 100 may provide a floating image including a content list (920). For example, as illustrated in FIG. 10, the electronic apparatus 100 may provide a floating image including a content list 1010 comprising a plurality of UI elements corresponding to a plurality of content. Here, when a user raises a hand, the electronic apparatus 100 may provide a highlight (or cursor) on the content list.

The electronic apparatus 100 may detect a gesture for scrolling (930). According to one or more embodiments, the electronic apparatus 100 may detect a gesture for scrolling based on a sensing value received from the camera 130 or the wearable device 400. Here, the gesture for scrolling may include a gesture moving in a horizontal direction or a gesture moving in a vertical direction.

The electronic apparatus 100 may scroll the content list in response to the gesture for scrolling (940). For example, when a gesture for scrolling in the right direction is detected, the electronic apparatus 100 may scroll the content list in the right direction. Here, when movement exceeds a preset value in the right direction, the electronic apparatus 100 may move the UI elements of the content list one step at a time.

The electronic apparatus 100 may detect a gesture for selecting one of a plurality of content included in the content list (950). Here, the gesture for selecting content may be a pressing gesture in the Z-axis direction while a highlight or focus is positioned on one of the plurality of UI elements, but is not limited thereto. For example, a gesture for selecting content may be detected while a highlight is positioned on a UI element corresponding to third content in the content list.

The electronic apparatus 100 may provide a floating image including the selected content (960). For example, when a gesture for selecting content is detected while a highlight is positioned on a UI element corresponding to the third content in the content list, the electronic apparatus 100 may provide a floating image including the selected third content.

According to an embodiment, the electronic apparatus 100 may provide an emotional expression of an avatar UI according to a user gesture input on the avatar UI while the avatar UI is displayed. For example, when the avatar UI is looking backward, if the avatar UI is touched, the electronic apparatus 100 may provide an avatar UI expressing a surprised emotion. As another example, when the head of the avatar UI is stroked, the electronic apparatus 100 may provide an avatar UI expressing a happy emotion.

According to an embodiment, the electronic apparatus 100 may provide a floating image including notification information received from an external apparatus.

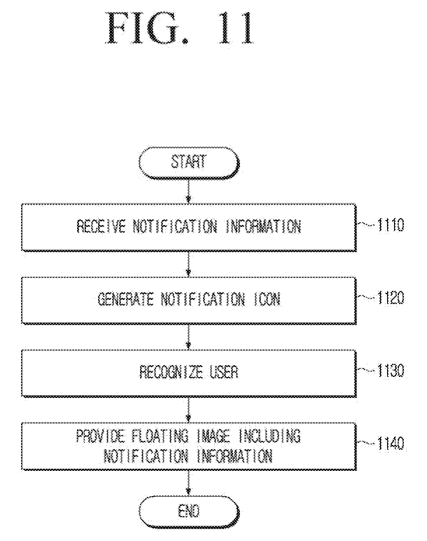

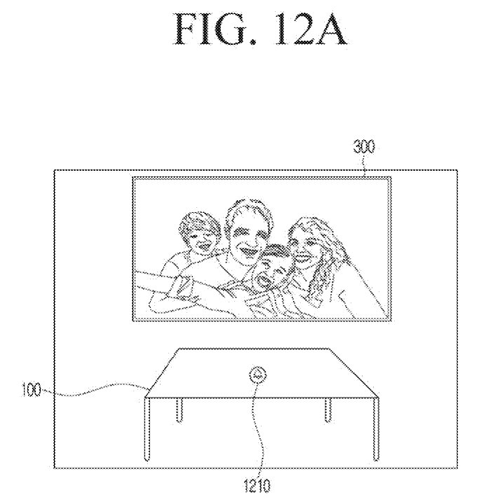

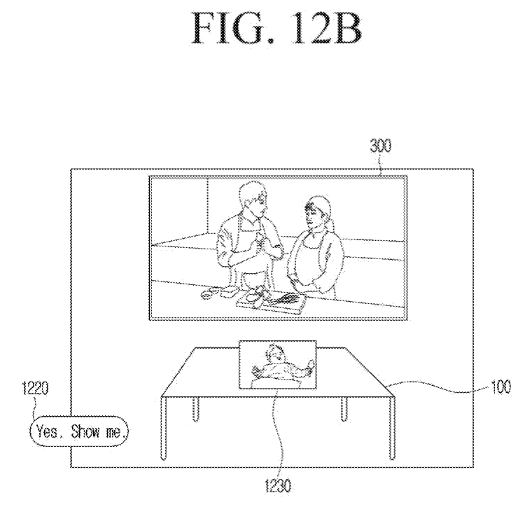

FIG. 11 is a flowchart and FIGS. 12A and 12B are views provided to explain an embodiment in which notification information received from an external apparatus is provided according to an embodiment.

First, the electronic apparatus 100 may receive notification information (1110). Here, the notification information may be notification information received by the external apparatus 300, and may include various types of notification information such as message reception, email reception, call reception, schedule alarms, application alarms, etc.

The electronic apparatus 100 may generate a notification icon (1120). Here, the notification icon is an icon for indicating that the notification information has been received, and may be a shape-type icon 1210 as illustrated in FIG. 12A, but is not limited thereto, and may be implemented in various forms such as text. In addition, the electronic apparatus 100 may notify the reception of the notification information through a speaker together with the notification icon. Here, the notification icon may be displayed for a preset period, but is not limited thereto, and may continue to be displayed until a user is recognized or a user input is received. Further, after the preset period elapses, the notification icon may be displayed by adjusting its color or brightness.

The electronic apparatus 100 may recognize a user (1130). Specifically, the electronic apparatus 100 may identify whether a user currently located near the electronic apparatus 100 is a pre-registered user. For example, the electronic apparatus 100 may identify whether the user is a pre-registered user by analyzing an image captured by the camera 130. As another example, the electronic apparatus 100 may identify whether the user is a pre-registered user based on user account information received from the wearable device 400 worn by the user. However, this is merely one embodiment, and the user may be recognized using various methods (e.g., fingerprint, iris, password, gaze, etc.).

The electronic apparatus 100 may provide a floating image including the notification information (1140). For example, the electronic apparatus 100 may provide notification information for guiding that a baby has awakened. In addition, as illustrated in FIG. 12B, when a user voice 1220 such as “Yes, show me” is input, the electronic apparatus 100 may provide a floating image including a baby cam screen 1230 corresponding to the notification information.

Accordingly, the user may check the notification information (or a screen corresponding to the notification information) using the electronic apparatus 100 without interfering with the viewing of the content displayed by the external apparatus 300.

According to an embodiment, the electronic apparatus 100 may display an image on the external apparatus 300 or the electronic apparatus 100 based on a gesture.

According to one or more embodiments, when a preset gesture toward the external apparatus 300 is detected while the electronic apparatus 100 provides a floating image including content, the electronic apparatus 100 may transmit information about the content currently displayed by the electronic apparatus 100 to the external apparatus 300, and the external apparatus 300 may provide content based on the information about the content currently displayed by the electronic apparatus 100.

According to one or more embodiments, when the user’s gaze is directed toward the external apparatus 300 while the electronic apparatus 100 provides a floating image including content, the electronic apparatus 100 may transmit information about the content currently displayed by the electronic apparatus 100 to the external apparatus 300, and the external apparatus 300 may provide content based on the information about the content currently displayed by the electronic apparatus 100. In other words, the electronic apparatus 100 may detect the user’s gaze or head direction and provide content on the electronic apparatus 100 or the external apparatus 300 that the user is viewing.

According to one or more embodiments, the electronic apparatus 100 may change or exchange the positions of information displayed by the electronic apparatus 100 and information displayed by the external apparatus 300 through a user gesture or a user voice.

According to an embodiment, the electronic apparatus 100 may recognize the external apparatus 300 positioned on the electronic apparatus 100 and provide augmented information. Here, the augmented information may be information provided by augmenting and providing information related to the external apparatus 300 around the external apparatus 300.

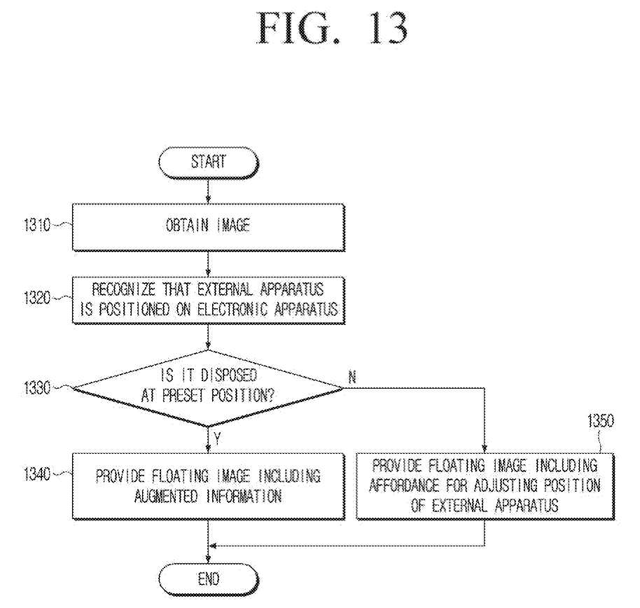

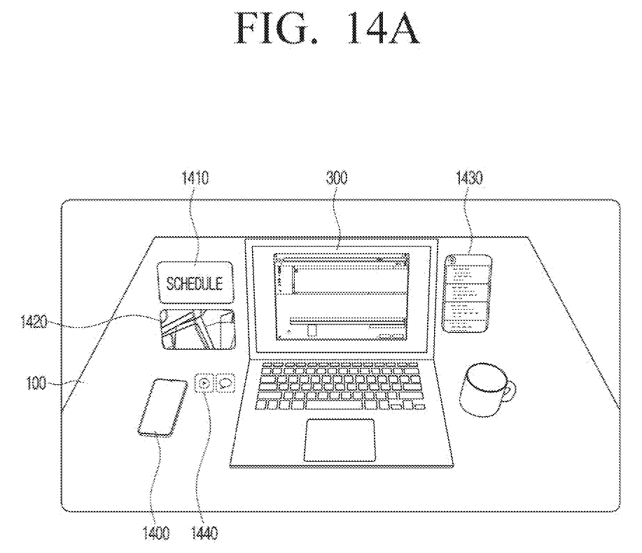

FIGS. 13 is a flowchart and FIGS. 14A and 14B are views provided to explain an embodiment in which augmented information is provided when an external apparatus is positioned on an electronic apparatus according to an embodiment.

The electronic apparatus 100 may obtain an image (1310). Here, the electronic apparatus 100 may obtain the image through the camera 130.

The electronic apparatus 100 may recognize that the external apparatus 300 is positioned on the electronic apparatus 100 (1320). In other words, when the electronic apparatus 100 is a table-type device, the electronic apparatus 100 may identify whether the external apparatus 300 is disposed on the electronic apparatus 100.

The electronic apparatus 100 may identify whether the external apparatus 300 is disposed at a preset position (1330). Here, the preset position may correspond to a central area of the electronic apparatus 100.

When the external apparatus 300 is disposed at the preset position (1330-Y), the electronic apparatus 100 may provide a floating image including augmented information (1340). Here, the augmented information may be information related to the external apparatus 300, and may include information about the external apparatus 300, information about a user logged in to the external apparatus 300, notification information, and the like.

According to an embodiment, as illustrated in FIG. 14A, when the external apparatus 300 is a laptop PC, the electronic apparatus 100 may include first augmented information 1410 corresponding to schedule information received from the external apparatus 300, second augmented information 1420 corresponding to a map application received from the external apparatus 300, and third augmented information 1430 corresponding to a mail application received from the external apparatus 300. In addition, when a user terminal 1400 is detected, the electronic apparatus 100 may provide fourth augmented information 1440 corresponding to an application icon provided by the user terminal 1400 around the user terminal 1400.

According to another embodiment, as illustrated in FIG. 14B, when the external apparatus 300 is a monitor, the electronic apparatus 100 may provide fifth augmented information 1450 corresponding to a calendar application received from the external apparatus 300, sixth augmented information 1460 corresponding to a schedule application, and seventh augmented information 1470 corresponding to a clock application.

When a user gesture is input on the augmented information illustrated in FIG. 14A or FIG. 14B, the electronic apparatus 100 may update the augmented information about which the gesture is input based on the user gesture. In addition, when the augmented information is updated, the electronic apparatus 100 may transmit the augmented information corresponding to the update to the external apparatus 300, and the external apparatus 300 may update the stored augmented information.

When the external apparatus 300 is not disposed at the preset position (1330-N), the electronic apparatus 100 may provide a floating image including an affordance for adjusting the position of the external apparatus 300 (1350). For example, when the external apparatus 300 is disposed on the right side rather than in the central area of the electronic apparatus 100, the electronic apparatus 100 may provide a floating image including an affordance for guiding movement of the external apparatus 300 to the left.

According to one or more embodiments, as illustrated in FIG. 14A, when a user cup is disposed on the electronic apparatus 100, the electronic apparatus 100 may detect the amount of water in the cup through a captured image and calculate the amount of water the user drinks. Accordingly, the electronic apparatus 100 may update health information of the user.

According to one or more embodiments, the electronic apparatus 100 may transmit and receive information with the external apparatus 300 or the wearable device 400 worn by a user so as to share information of each apparatus (e.g., charging information, schedule information, etc.). In this case, when the information of the electronic apparatus 100, the external apparatus 300, or the wearable device 400 is updated, the electronic apparatus 100, the external apparatus 300, and the wearable device 400 may share the updated information.

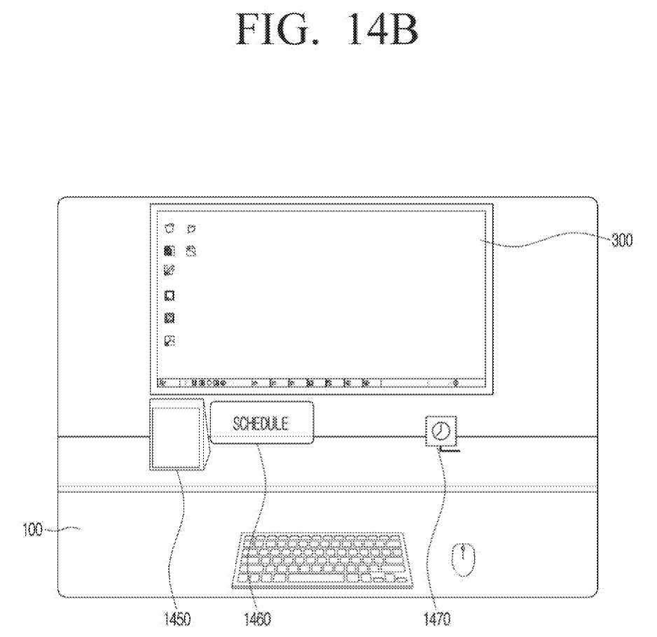

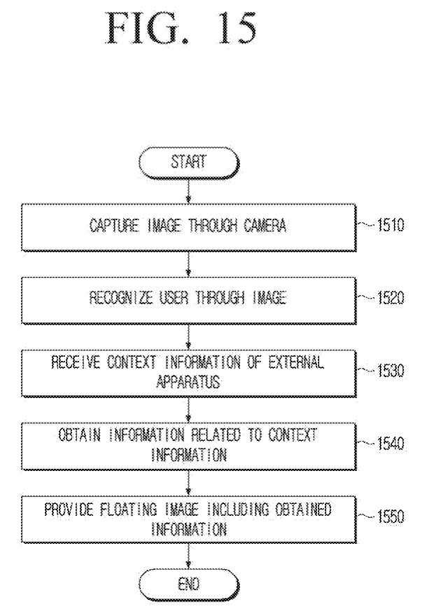

FIG. 15 is a flowchart provided to explain a method of controlling an electronic apparatus that provides a floating image according to an embodiment.

The electronic apparatus 100 captures an image through the camera 130 (1510). Here, the image may include a user.

The electronic apparatus 100 recognizes the user through the image (1520). In other words, the electronic apparatus 100 may recognize the user by identifying whether the user included in the image is a pre-registered user.

The electronic apparatus 100 may receive context information of the external apparatus 300 from the external apparatus 300 (1530). Here, the context information is information describing specific data, state, environment, or usage scenario associated with the external apparatus 300. For example, the context information may include identification information of the external apparatus 300, communication connection information of the external apparatus 300, user account information of the external apparatus 300, state information of the external apparatus 300, information about content provided by the external apparatus 300, notification information obtained by the external apparatus 300, etc.

The electronic apparatus 100 obtains information related to the context information (1540). According to one or more embodiments, the context information may include state information of the external apparatus 300. When the electronic apparatus 100 identifies that the external apparatus 300 is in an off state based on the state information of the external apparatus 300, the electronic apparatus 100 may obtain information about a greeting screen. When the electronic apparatus 100 identifies that the external apparatus 300 is in a state of displaying a daily board based on the state information of the external apparatus 300, the electronic apparatus 100 may obtain private information of the user. When the electronic apparatus 100 identifies that the external apparatus 300 is in a state of displaying an art image based on the state information of the external apparatus 300, the electronic apparatus 100 may obtain information about the art image. When the electronic apparatus 100 identifies that the external apparatus 300 is in a state of displaying content based on the state information of the external apparatus 300, the electronic apparatus 100 may obtain information about an avatar UI.

The electronic apparatus 100 provides a floating image including the obtained information (1550). According to one or more embodiments, the context information may include information about content provided by the external apparatus 300. The electronic apparatus 100 may provide a floating image including an avatar UI through the aerial image display 110, and may provide a conversation affordance on the avatar UI or provide emotional expressions using the avatar UI, based on the information about the content received from the external apparatus 300.

The methods according to an embodiment may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore^{TM}) or directly between two user devices 20 (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server, or may be temporarily generated.

The methods according to various embodiments may be implemented as software including an instruction stored in machine-readable storage media, which can be read by machine (e.g.: computer). The machine refers to a device that calls instructions stored in a storage medium, and can operate according to the called instructions, and the device may include an electronic apparatus (e.g.: TV) according to the aforementioned embodiments.

The machine-readable storage medium may be provided in a form of a non-transitory storage medium. Here, the term ‘non-transitory’ means that the storage medium is tangible without including a signal (e.g., electromagnetic waves), and does not distinguish whether data are semi-permanently or temporarily stored in the storage medium. For example, a ‘non-transitory storage medium’ may include a buffer in which data is temporarily stored.

In case the instruction is executed by one or more processors individually or collectively, the one or more processors may perform a function corresponding to the instruction by itself, or by using other components under its control. An instruction may include a code that is generated or executed by a compiler or an interpreter.

Although example embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. An electronic apparatus comprising:
an aerial imaging display comprising:
an image module configured to form an original image to be provided in mid-air and transmit light for the original image; and
a floating module configured to provide a floating image by forming a real image of the original image at a preset position in mid-air through the light for the original image;
a communication interface;
a camera;
memory storing instructions; and
at least one processor,
wherein the instructions, when executed by the at least one processor individually or collectively, cause the electronic apparatus to:
obtain an image through the camera;
based on recognizing a user through the image, receive context information of an external apparatus from the external apparatus through the communication interface;
obtain information related to the context information of the external apparatus; and
provide a floating image comprising the information related to the context information through the aerial imaging display.

2. The electronic apparatus as claimed in claim 1, wherein the context information comprises state information of the external apparatus, and
wherein the instructions, when executed by the at least one processor individually or collectively, further cause the electronic apparatus to:
based on identifying that the external apparatus is in an off state based on the state information of the external apparatus, obtain information about a greeting screen;
based on identifying that the external apparatus is in a state of displaying a daily board based on the state information of the external apparatus, obtain private information of the user;
based on identifying that the external apparatus is in a state of displaying an art image based on the state information of the external apparatus, obtain information about the art image; and
based on identifying that the external apparatus is in a state of displaying content based on the state information of the external apparatus, obtain information about an avatar user interface (UI).

3. The electronic apparatus as claimed in claim 1, wherein the context information comprises information about content provided by the external apparatus, and
wherein the instructions, when executed by the at least one processor individually or collectively, further cause the electronic apparatus to:
provide a floating image comprising an avatar user interface (UI) through the aerial imaging display; and
provide a (i) conversation affordance on the avatar UI or (ii) an emotional expression on the avatar UI, based on the information about the content received from the external apparatus.

4. The electronic apparatus as claimed in claim 1, wherein the instructions, when executed by the at least one processor individually or collectively, further cause the electronic apparatus to:
provide a floating image comprising a content list that comprises a plurality of contents through the aerial imaging display;
based on detecting a gesture for scrolling the content list, scroll the content list in the floating image; and
based on detecting a gesture for selecting a content of the plurality of contents in the content list, provide a floating image comprising the selected content through the aerial imaging display.

5. The electronic apparatus as claimed in claim 1, wherein the context information comprises notification information, and
wherein the instructions, when executed by the at least one processor individually or collectively, further cause the electronic apparatus to:
provide a floating image comprising a notification icon corresponding to the notification information; and
based on identifying that the user is gazing at the aerial imaging display through the camera, provide a floating image comprising the notification information.

6. The electronic apparatus as claimed in claim 1, wherein the instructions, when executed by the at least one processor individually or collectively, further cause the electronic apparatus to:
based on recognizing the user through the image, request user information from a wearable device worn by the user through the communication interface; and
authenticate the user based on the user information received from the wearable device.

7. The electronic apparatus as claimed in claim 6, wherein the instructions, when executed by the at least one processor individually or collectively, further cause the electronic apparatus to:
based detecting a gesture for selecting a user interface (UI) element in the floating image after the user is authenticated, identify whether the UI element has an interaction; and
based on identifying that the UI element has an interaction, generate information about a vibration pattern and transmit the information about the vibration pattern to the wearable device.

8. The electronic apparatus as claimed in claim 1, wherein the instructions, when executed by the at least one processor individually or collectively, further cause the electronic apparatus to:
based on recognizing that the external apparatus is provided at the electronic apparatus using an image obtained through the camera, identify whether the external apparatus is disposed at a preset position;
based on identifying that the external apparatus is disposed at the preset position, provide a floating image comprising augmented information around the external apparatus; and
based on identifying that the external apparatus is not disposed at the preset position, provide a floating image comprising an affordance for adjusting a position of the external apparatus around the external apparatus.

9. The electronic apparatus as claimed in claim 8, wherein the instructions, when executed by the at least one processor individually or collectively, further cause the electronic apparatus to:
based on detecting a gesture for controlling the augmented information in the floating image, update the augmented information based on the gesture; and
transmit information about the updated augmented information to the external apparatus through the communication interface.

10. The electronic apparatus as claimed in claim 8, wherein the instructions, when executed by the at least one processor individually or collectively, further cause the electronic apparatus to:
based on receiving information for updating augmented information from the external apparatus, update the augmented information based on the received information.

11. A method of controlling an electronic apparatus comprising an aerial imaging display and a camera, the aerial imaging display being configured to form an original image to be provided in mid-air, transmit light for the original image, and provide a floating image by forming a real image of the original image at a preset position in mid-air through the light for the original image, the method comprising:
obtaining an image through the camera;
based on recognizing a user through the image, receiving context information of an external apparatus from the external apparatus;
obtaining information related to the context information of the external apparatus; and
providing a floating image comprising the information related to the context information through the aerial imaging display.

12. The method as claimed in claim 11, wherein the context information comprises state information of the external apparatus, and
wherein the obtaining the information related to the context information comprises:
based on identifying that the external apparatus is in an off state based on the state information of the external apparatus, obtaining information about a greeting screen;
based on identifying that the external apparatus is in a state of displaying a daily board based on the state information of the external apparatus, obtaining private information of the user;
based on identifying that the external apparatus is in a state of displaying an art image based on the state information of the external apparatus, obtaining information about the art image; and
based on identifying that the external apparatus is in a state of displaying content based on the state information of the external apparatus, obtaining information about an avatar user interface (UI).

13. The method as claimed in claim 11, wherein the context information comprises information about content provided by the external apparatus,
wherein the providing the floating image comprises providing a floating image comprising an avatar user interface (UI), and
wherein the method further comprises providing (i) a conversation affordance on the avatar UI or (ii) an emotional expression on the avatar UI, based on the information about the content received from the external apparatus.

14. The method as claimed in claim 11, wherein the providing the floating image comprises providing a floating image comprising a content list that comprises a plurality of contents through the aerial imaging display, and
wherein the method further comprises:
based on detecting a gesture for scrolling the content list in the floating image, scrolling the content list in the floating image; and
based on detecting a gesture for selecting a content of the plurality of contents in the content list, providing a floating image comprising the selected content through the aerial imaging display.

15. The method as claimed in claim 11, wherein the context information comprises notification information, and
wherein the providing the floating image comprises:
providing a floating image comprising a notification icon corresponding to the notification information; and
based on identifying that the user is gazing at the aerial imaging display through the camera, providing a floating image comprising the notification information.

16. The method of claim 11, further comprising:
based on recognizing the user through the image, requesting user information from a wearable device worn by the user, and
authenticating the user based on the user information received from the wearable device.

17. The method of claim 16, further comprising:
based detecting a gesture for selecting a user interface (UI) element in the floating image after the user is authenticated, identifying whether the UI element has an interaction; and
based on identifying that the UI element has the interaction, generating information about a vibration pattern and transmitting the information about the vibration pattern to the wearable device.

18. The method of claim 11, further comprising:
based on recognizing that the external apparatus is provided at the electronic apparatus using an image obtained through the camera, identifying whether the external apparatus is disposed at a preset position,
wherein the providing the floating image comprises:
based on identifying that the external apparatus is disposed at the preset position, providing a floating image comprising augmented information around the external apparatus; and
based on identifying that the external apparatus is not disposed at the preset position, providing a floating image comprising an affordance for adjusting a position of the external apparatus around the external apparatus.

19. The method of claim 18, further comprising:
based on detecting a gesture for controlling the augmented information in the floating image, updating the augmented information based on the gesture; and
transmitting information about the updated augmented information to the external apparatus.

20. The method of claim 18, further comprising, based on receiving information for updating the augmented information from the external apparatus, updating the augmented information based on the received information.
